(19) United States
(12) Patent Application Publication
(10) Pub. No.: US 2026/0140364 A1
(43) Pub. Date: May 21, 2026

(54) TRANSMISSIVE GLASS COVER FOR LIDAR SENSOR

(71) Applicants: HYUNDAI MOTOR COMPANY, Seoul (KR); KIA CORPORATION, Seoul (KR); KCC GLASS Corporation, Seoul (KR); ECOPLASTIC CORPORATION, Gyeongju-si (KR)

(72) Inventors: Seon-Yong AN, Hwaseong-si (KR); Kyoung-Chun KWEON, Hwaseong-si (KR); Sae-Ah KIM, Hwaseong-si (KR); Seok KIM, Pyeongtaek-si (KR); Jun-Seok CHOI, Yongin-si (KR); Woo-Sue HAN, Hanam-si (KR); Gyeom-Son SEONG, Gunpo-si (KR); Kuk-Bum LEE, Sejong-si (KR); Yeong-Mi KIM, Sejong-si (KR); Wan-Ho SON, Gunpo-si (KR)

(21) Appl. No.: 19/195,309

(22) Filed: Apr. 30, 2025

(30) Foreign Application Priority Data
Nov. 21, 2024 (KR) 10-2024-0167208

(51) Int. Cl. G02B 27/00; G01S 7/481; G02B 1/11; H05B 3/86

(52) U.S. Cl. CPC G02B 27/0006; G01S 7/4813; G02B 1/11; H05B 3/86

(57) ABSTRACT

A transmissive glass cover for a light detection and ranging (LiDAR) sensor includes a first glass layer, a LiDAR transmissive film bonded to a front surface of the first glass layer and configured to transmit near-infrared light, and a heat wire layer interposed between the LiDAR transmissive film and the first glass layer, to thereby improve vulnerability to environmental factors of a LiDAR cover and increase transmittance and durability of the LiDAR sensor.

### CROSS-REFERENCE TO RELATED APPLICATION

This application claims priority to Korean Patent Application No. 10-2024-0167208, filed on Nov. 21, 2024, which is incorporated herein by reference in its entirety.

### TECHNICAL FIELD

The present disclosure relates to a transmissive glass cover for a light detection and ranging (LiDAR) sensor.

### BACKGROUND

Autonomous vehicle can include LiDAR units for detecting obstacles and the like near the vehicle. For example, a LiDAR sensor may detect objects based on light reflected from front objects by emitting infrared light and may be positioned at the front and top of the vehicle.

Covers for a LiDAR sensor may provide a simple protection function, and the covers may be made of plastic, glass, or other materials.

In some cases, the covers for a LiDAR sensor may not be considered in the design of vehicles due to limitations in technology and manufacturing, and applicable materials may be limited, which may make it difficult to improve performance degradation due to environmental factors.

In some cases, LiDAR covers may be vulnerable to environmental factors such as a change in temperature, humidity, and a physical impact and may lower long-term performance and reliability of the sensor.

In some cases, the design of the cover often may not match the appearance of the vehicle and thus fails to satisfy the design requirements of vehicle manufacturers.

### SUMMARY

The present disclosure describes a transmissive glass cover for a light detection and ranging (LiDAR) sensor, which is capable of improving vulnerability to environmental factors of a LiDAR cover and improving transmittance and durability of a LiDAR.

According to one aspect of the subject matter described in this application, a transmissive glass cover for a light detection and ranging (LiDAR) sensor includes a first glass layer, a LiDAR transmissive film bonded to a front surface of the first glass layer and configured to transmit near-infrared light, and a heat wire layer disposed between the LiDAR transmissive film and the first glass layer. For example, the near-infrared (NIR) light is a particular range of electromagnetic spectrum having a wavelength longer than a wavelength of visible light. For example, the wavelength of NIR light can be from 780 nm to 2500 nm.

Implementations according to this aspect can include one or more of the following features. For example, the LiDAR transmissive film can include a polyvinyl butyral (PVB) film. In some examples, the PVB film can be printed with black infrared (IR) ink.

In some implementations, the heat wire layer can define a surface configured to generate heat. In some implementations, the transmissive glass cover can further include a first anti-reflection (AR) coating layer bonded to a first surface of the LiDAR transmissive film, where a second surface of the LiDAR transmissive film is bonded to the first surface of the first glass layer, and a second AR coating layer bonded to a second surface of the first glass layer opposite to the first surface of the first glass layer.

In some implementations, the transmissive glass cover can further include a second glass layer bonded to a first surface of the LiDAR transmissive film, where a second surface of the LiDAR transmissive film is bonded to the first surface of the first glass layer. In some examples, the first glass layer and the second glass layer can have a near-infrared transmittance of 88% or more. In some examples, an iron content of the first glass layer is greater than an iron content of the second glass layer.

In some implementations, the transmissive glass cover can further include a first anti-reflection (AR) coating layer bonded to a first surface of the second glass layer, where a second surface of the second glass layer is bonded to the first surface of the LiDAR transmissive film, and a second AR coating layer bonded to a second surface of the first glass layer.

In some implementations, a width of the heat wire layer can be less than a width of the LiDAR transmissive film and the first glass layer.

According to another aspect, a transmissive glass cover for a light detection and ranging (LiDAR) sensor includes a glass layer, a first anti-reflection (AR) coating layer bonded to a first surface of the glass layer, a second AR coating layer bonded to a second surface of the glass layer opposite to the first surface of the glass layer, and a heat wire layer disposed between the glass layer and the second AR coating layer.

Implementations according to this aspect can include one or more of the following features. For example, the glass layer can have a near-infrared transmittance of 88% or more and has a black or gray color. In some examples, the heat wire layer can define a surface configured to generate heat. In some implementations, a width of the heat wire layer can be less than a width of the glass layer and the second AR coating layer.

According to another aspect, a transmissive glass cover for a light detection and ranging (LiDAR) sensor includes a glass layer, a first anti-reflection (AR) coating layer bonded to a first surface of the glass layer, a second AR coating layer bonded to a second surface of the glass layer, and a heat wire layer disposed between the glass layer and the first AR coating layer.

Implementations according to this aspect can include one or more of the following features. For example, the first AR coating layer and the second AR coating layer can be printed with black infrared (IR) ink. In some examples, the glass layer has a near-infrared transmittance of 88% or more. In some examples, the heat wire layer can define a surface configured to generate heat. In some examples, a width of the heat wire layer is less than a width of the glass layer and the first AR coating layer.

In some examples, the front or roof of a vehicle may be an exposed type regardless of the design of the vehicle to improve LiDAR transmittance performance.

Accordingly, the present disclosure considers the design of the vehicle, the improvement of LiDAR transmittance performance improvement, and energy efficiency.

That is, the transmissive glass cover can be used as a separate cover that can be hidden when the built-in LiDAR mounted inside a vehicle for design improvement is applied, and the high-efficiency LiDAR transmittance glass system provide various functions to improve LiDAR transmittance and energy efficiency.

In terms of improving LiDAR transmittance, the application of the transmissive glass and the AR coating and the heating function can help prevent freezing and frost of the LiDAR cover.

In addition, it can be possible to optimize the heating pattern by direct heat generation, indirect heat generation, or the like, thereby increasing energy efficiency.

### BRIEF DESCRIPTION OF THE DRAWINGS

FIG. 1 illustrates an example of a transmissive glass cover for a light detection and ranging (LiDAR) sensor.

FIG. 2 illustrates an example of a transmissive glass cover for a LiDAR sensor.

FIG. 3 illustrates an example of a transmissive glass cover for a LiDAR sensor.

FIG. 4 illustrates an example of a transmissive glass cover for a LiDAR sensor.

### DETAILED DESCRIPTION

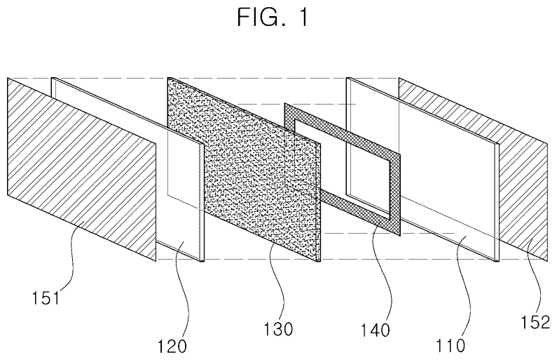

FIG. 1 illustrates an example of a transmissive glass cover for a light detection and ranging (LiDAR) sensor. Hereinafter, the transmissive glass cover for a LiDAR sensor will be described.

The present disclosure is a transmissive glass cover for a LiDAR sensor, which improves the vulnerability of a LiDAR cover to environmental factors and improving LiDAR transmittance and durability.

That is, when a LiDAR system is configured on the front or roof of a vehicle, design matching is lowered due to external exposure, and even in the case of a grill type, the risk of a failure is high due to external exposure, and the glass cover of the present disclosure is applied as a separate cover for a built-in structure that hides a LiDAR sensor inside a vehicle, thereby preventing damage to an expensive LiDAR and improving design matching.

In some implementations, considering that scattering of the LiDAR can occur and transmittance can be reduced due to environmental factors such as a change in temperature, humidity, and a physical impact, in particular, frost in winter, the environmental impact is minimized so that LiDAR transmittance can be maintained at 95% or more.

In some examples, the transmissive glass cover for a LiDAR sensor of FIG. 1 can be, for example, a cover system for a LiDAR sensor embedded in a roof and can be mounted in the form of a face cover on the front of a structure composed of a roof upper and a roof lower.

The roof upper can be configured considering protecting the sensor from an external shock along with the face cover, minimizing air resistance that can occur during driving of the vehicle through an aerodynamic design, and optimizing a position and angle of the LiDAR sensor.

In some implementations, the roof lower is a lower end part of the LiDAR cover system, is a design element which supports and protects the LiDAR sensor and in which shock absorption and durability are important, can be made of a solid material, is fixed to the vehicle structure using a lower bracket, and can absorb vibrations and prevent a shock due to the lower bracket.

The glass cover as the face cover mounted on an open front of the cover system can protect the LiDAR sensor from direct environmental exposure and have a near-infrared transmittance of 95% or more.

In some implementations, the glass cover of the present disclosure can prevent freezing or frost, thereby preventing deterioration of performance of the LiDAR sensor in winter.

Specifically, the transmissive glass cover for a LiDAR sensor includes a double glass in which a first glass layer 110 and a second glass layer 120 are double-bonded for durability.

In some implementations, a LiDAR transmissive film 130 can be bonded between the first glass layer 110 and the second glass layer 120, and a heat wire layer 140 can be formed on a rear surface of the LiDAR transmissive film 130.

In some examples, a first AR coating layer 151 can be bonded on a front surface of the second glass layer 120, and a second AR coating layer 152 can be bonded on a rear surface of the first glass layer 110.

The first glass layer 110 and the second glass layer 120 are low-iron glass and high-transmittance glass with a low iron content and a bluish tint removed.

In some examples, the iron content of the first glass layer 110 can be greater than the iron content of the second glass layer 120.

The LiDAR transmissive film 130 can be a polyvinyl butyral (PVB) film having near-infrared transmissive performance and can be a transparent PVB film printed with black infrared (IR) ink that is a near-infrared transmissive dye.

To prevent exposure of the LiDAR sensor and consider a design, a black pigment is applied to the LiDAR transmissive film 130, but when a general black pigment containing carbon is applied, the near-infrared transmittance is only about 55%.

In some examples, frost and freezing on the sensor cover can be removed by heat through the heat wire layer 140. The heat wire layer can be a surface (direct) heat generator or a heat wire (indirect) heat generator. For instance, the heat wire layer 140 can have a surface or plane configured to generate heat. In some examples, the heat wire layer 140 can have a surface configured to transmit heat generated by a heat wire. In some examples, an overall size (e.g., lateral widths) of the heat wire layer 140 can be less than an overall size of the other layers such as LiDAR transmissive film 130, the first glass layer 110, the second glass layer, and AR coating layers 151, 152. In some examples, the heat wire layer 104 can have a rectangular frame shape having an opening at the center portion of thereof.

The first AR coating layer 151 and the second AR coating layer 152 are anti-reflection coating layers and can increase the LiDAR transmittance by about 2 to 3%.

In this way, the LiDAR transmissive glass cover of FIG. 1 can increase the LiDAR transmittance and at the same time, satisfy heat generation performance.

That is, transparent glass is used to achieve high LiDAR transmittance performance, and in addition to the low-iron glass in one example, a glass surface with a LiDAR transmittance of 88% or more can be applied.

A thickness of a single glass can range from 0.5 to 3t, and the glass can be a dark color (black, gray, etc.) for design improvement and internal shielding.

In some examples, double-sided or single AR coating can be applied to the front and rear surfaces of the glass, and when the double-sided AR coating is applied, the LiDAR transmittance can be increased by 5% or more, and the position of the AR coating is changed differently from the implementation shown in FIG. 1.

In some implementations, as a system that implements the performance of the heat sink through direct and indirect heat generation, the heat generation function is positioned on the rear surface of the glass to implement heat generation performance, and the system can be manufactured as a direct heat generator using transparent conductive ink, and other conductive materials can be applied to indirect heat generation.

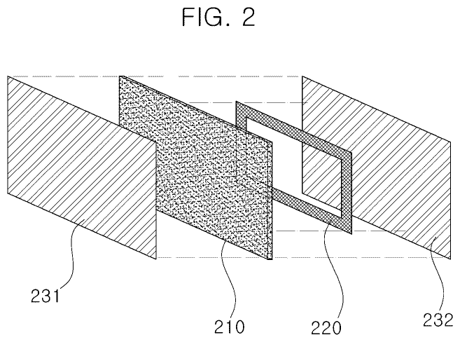

FIG. 2 illustrates an example of a transparent glass cover for a LiDAR sensor. Hereinafter, the transparent glass cover for a LiDAR sensor will be described with reference to FIG. 2, but description of the same configuration and function as those of the transparent glass cover of FIG. 1 can be omitted.

The transparent glass cover can include one glass layer 210, and a heat wire layer 220 can be formed on a rear surface of the glass layer 210.

In some implementations, a first AR coating layer 231 can be bonded to a front surface of the glass layer 210, and a second AR coating layer 232 can be bonded to a rear surface of the glass layer 210 on which the heat wire layer 220 is formed.

In some examples, the glass layer 210 can be low-iron glass, and the glass can be a dark color (black, gray, etc.) for design improvement and internal shielding.

Accordingly, the glass layer 210 in FIG. 2 can help prevent external exposure of the LiDAR sensor, have near-infrared transmissive performance, and reduce manufacturing cost with a minimum configuration in comparison to the cover shown in FIG. 1.

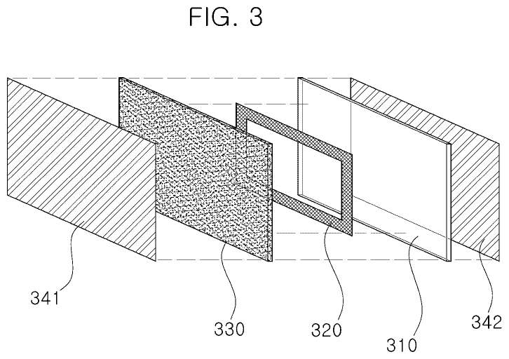

FIG. 3 illustrates an example of a transmissive glass cover for a LiDAR sensor.

The transmissive glass cover for a LiDAR sensor can include one glass layer 310, a LiDAR transmissive film 330 can be bonded to the front surface of the glass layer 310, and a heat wire layer 320 can be formed on a rear surface of the LiDAR transmissive film 330.

In some implementations, a first AR coating layer 341 can be bonded on a front surface of the LiDAR transmissive film 330, and a second AR coating layer 342 can be bonded on a rear surface of the glass layer 310.

The glass layer 310 is low-iron glass and high transmissive glass with a low iron content and a bluish tint removed.

The LiDAR transmissive film 330 can be a polyvinyl butyral (PVB) film having near-infrared transmissive performance and can be a transparent PVB film printed with black IR ink that is a near-infrared transmissive dye.

Accordingly, the heat wire layer 320 can be shielded by the black PVB film.

In some examples, the heat wire layer 320 can be a surface (direct) heat generator or heat wire (indirect) heat generator. For instance, the heat wire layer 320 can have a surface or plane configured to generate heat. In some examples, the heat wire layer 320 can have a surface configured to transmit heat generated by a heat wire.

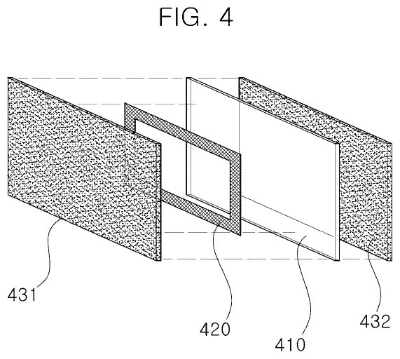

FIG. 4 illustrates an example of a transmissive glass cover for a LiDAR sensor. The transmissive glass cover for a LiDAR sensor includes one glass layer 410, and a heat wire layer 420 can be formed on a rear surface of the glass layer 410, thereby increasing heat generation performance.

In some implementations, a first AR coating layer 431 can be bonded on a front surface of the glass layer 410 on which the heat wire layer 420 is formed, and a second AR coating layer 432 can be bonded on a rear surface of the glass layer 410.

The glass layer 410 is low-iron glass and high transmissive glass with a low iron content and a bluish tint removed.

The first AR coating layer 431 and the second AR coating layer 432 are AR coating layers and can be printed with black IR ink, which is a near-infrared transparent dye.

Accordingly, the heat wire layer 320 can be shielded by a black printing layer, and the heat wire layer 420 can be a surface (direct) heat generator or a heat wire (indirect) heat generator. For instance, the heat wire layer 420 can have a surface or plane configured to generate heat. In some examples, the heat wire layer 420 can have a surface configured to transmit heat generated by a heat wire.

As described above, the transmissive glass cover for a LiDAR sensor of the present disclosure can be used as a separate cover that can be hidden when a built-in LiDAR mounted inside a vehicle for design improvement is applied, and various functions can be added to improve LiDAR transmittance and energy efficiency.

In particular, in terms of improving LiDAR transmittance, the application of transmissive glass and AR coating and the heat generation function can prevent freezing and frost of the LiDAR cover, and the heating pattern can be optimized by direct heat generation, indirect heat generation, or the like, thereby increasing energy efficiency.

Although the present disclosure has been described above with reference to the exemplary drawings, the present disclosure is not limited to the described implementations, and it is apparent to those skilled in the art that various modifications and changes can be made without departing from the spirit and scope of the present disclosure. Therefore, these modified examples or changed examples should be included in the claims of the present disclosure, and the scope of the present disclosure should be construed based on the appended claims.

What is claimed is:

1. A transmissive glass cover for a light detection and ranging (LiDAR) sensor, comprising:
a first glass layer;
a LiDAR transmissive film bonded to a first surface of the first glass layer and configured to transmit near-infrared light; and
a heat wire layer disposed between the LiDAR transmissive film and the first glass layer.

2. The transmissive glass cover of claim 1, wherein the LiDAR transmissive film comprises a polyvinyl butyral (PVB) film.

3. The transmissive glass cover of claim 2, wherein the PVB film is printed with black infrared (IR) ink.

4. The transmissive glass cover of claim 1, wherein the heat wire layer defines a surface configured to generate heat.

5. The transmissive glass cover of claim 1, further comprising:
a first anti-reflection (AR) coating layer bonded to a first surface of the LiDAR transmissive film, wherein a second surface of the LiDAR transmissive film is bonded to the first surface of the first glass layer; and
a second AR coating layer bonded to a second surface of the first glass layer opposite to the first surface of the first glass layer.

6. The transmissive glass cover of claim 1, further comprising a second glass layer bonded to a first surface of the LiDAR transmissive film, wherein a second surface of the LiDAR transmissive film is bonded to the first surface of the first glass layer.

7. The transmissive glass cover of claim 6, wherein the first glass layer and the second glass layer have a near-infrared transmittance of 88% or more.

8. The transmissive glass cover of claim 6, wherein an iron content of the first glass layer is greater than an iron content of the second glass layer.

9. The transmissive glass cover of claim 6, further comprising:
a first anti-reflection (AR) coating layer bonded to a first surface of the second glass layer, wherein a second surface of the second glass layer is bonded to the first surface of the LiDAR transmissive film; and
a second AR coating layer bonded to a second surface of the first glass layer.

10. The transmissive glass cover of claim 1, wherein a width of the heat wire layer is less than a width of the LiDAR transmissive film and the first glass layer.

11. A transmissive glass cover for a light detection and ranging (LiDAR) sensor, comprising:
a glass layer;
a first anti-reflection (AR) coating layer bonded to a first surface of the glass layer;
a second AR coating layer bonded to a second surface of the glass layer opposite to the first surface of the glass layer; and
a heat wire layer disposed between the glass layer and the second AR coating layer.

12. The transmissive glass cover of claim 11, wherein the glass layer has a near-infrared transmittance of 88% or more and has a black or gray color.

13. The transmissive glass cover of claim 11, wherein the heat wire layer defines a surface configured to generate heat.

14. The transmissive glass cover of claim 11, wherein a width of the heat wire layer is less than a width of the glass layer and the second AR coating layer.

15. A transmissive glass cover for a light detection and ranging (LiDAR) sensor, comprising:
a glass layer;
a first anti-reflection (AR) coating layer bonded to a first surface of the glass layer;
a second AR coating layer bonded to a second surface of the glass layer; and
a heat wire layer disposed between the glass layer and the first AR coating layer.

16. The transmissive glass cover of claim 15, wherein the first AR coating layer and the second AR coating layer are printed with black infrared (IR) ink.

17. The transmissive glass cover of claim 15, wherein the glass layer has a near-infrared transmittance of 88% or more.

18. The transmissive glass cover of claim 15, wherein the heat wire layer defines a surface configured to generate heat.

19. The transmissive glass cover of claim 15, wherein a width of the heat wire layer is less than a width of the glass layer and the first AR coating layer.
